(19) United States
(12) Patent Application Publication
(10) Pub. No.: US 2008/0094202 A1
(43) Pub. Date: Apr. 24, 2008

(54) Method for conditional scheduling of security system events

(75) Inventor: Christopher D. Martin, Plainview, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/584,681

(22) Filed: Oct. 19, 2006

(51) Int. Cl. G08B 29/00; G08B 13/00

(52) U.S. Cl. 340/506; 340/541

(57) ABSTRACT

A method of operating a security system that allows an end user to program a scheduled time for an event to take place and a condition that must be met if the event is to occur. The security system memory is programmed with time information, event condition information, and event action information. The event condition information may include zone setting information, fault information, zone type information, and user selected information. The event action may consist of transmitting an alarm message, transmitting an email, transmitting a user interface message, activating a specified zone (arm-away or arm-stay), activating a camera, deactivating a specified zone (disarm). During operation, the current time is compared with the time information, then status information of the security system is read if the current time matches the time information, and the event action is executed if the event condition is satisfied by the status information.

### TECHNICAL FIELD

This invention relates to security systems, and in particular to conditional scheduling of security system events.

### BACKGROUND ART

Many premises monitored by security systems have occupants whose busy schedules cause them to come and go during the day for work, school, or various errands. These busy households also have many workers performing tasks on their premises, such as landscapers or house cleaning crews. The constant arming and disarming of different zones to accommodate their busy schedule is a bothersome to the homeowner. In addition, some zones of the security system become nuisance false alarm generators. The homeowner consequently disarms the zones where there is a lot of activity and where false alarms are likely, leaving the areas and possibly the entire premises unprotected. An example of this is a homeowner who does not arm the security system when he runs an errand because he is expecting the children to come home from school before he gets home. In this case it would be better to have the security system armed when the homeowner leaves, and at the scheduled time of the children's arrival home have the security system check if the system is armed and if it is then disarm it. Another example would be when a homeowner goes away on vacation. During this time he would normally arm the zone for the outside gate to the yard, but the anticipation of the landscaper during the vacation time would cause the homeowner to disarm that zone for the duration of the vacation. It would be desirable to have a security system that would check if the zone is armed during the scheduled time of the landscaper and disarm it if it is and then rearm it.

Additionally it would be desirable for a homeowner to know when there is a fault in the zone scheduled to be armed. For example when the zone with the gate to the pool area is to be armed (prior to children coming home from school) and the gate is open, an email or instant message may be sent to the homeowner, or an alarm, chime, or voice message may be transmitted.

It would also be desirable for a homeowner to know if and/or when there is a fault in a scheduled zone. For example when a security system zone is scheduled to be disarmed to allow a latch-key child in the house, the homeowner would receive an email or instant message when there was a fault (i.e. when the door was opened). Or conversely the homeowner would receive an email when there was no fault for a specified duration, signifying the child never made it home.

It is therefore an object of the present invention to provide a security system where an end user (or homeowner) can schedule events such as disarming of zones regardless of the security system's arming state.

It is a further object of the present invention to provide a security system where an end user can schedule multiple events at different times.

It is a further object of the present invention to provide a security system where an end user can program one or more conditions upon which the scheduled event may take place.

It is a further object of the present invention to provide a security system that reads the status of the alarm system and uses it to determine if the conditions of the scheduled event have been met.

It is a further object of the present invention to provide a security system that schedules an event to take place for a specified duration of time.

Finally it is a further object of the present invention to provide a security system where the end user can select and program the alarm system to perform a variety of actions. For example, arming or disarming one or more zones, transmitting an email, sending a chime to a user interface, transmitting a voice message, transmitting an alarm message, and/or activating a camera.

### DISCLOSURE OF THE INVENTION

The present invention is a method of operating a security system that allows an end user to schedule an event and associate a condition that must be met if the event is to take place. The first step of the method is to program the security system memory with time information, event condition information, and event action information. The time information includes day of week and time of day information for a start time and a duration time. The time information may also include date information. The event condition information includes zone setting information, fault information, zone type information, and user selected information. The event action consists of a zone setting action, a zone fault action, a zone problem action, and a zone no-fault action. The zone setting action would typically be an arming or disarming of one or more zones. The zone fault action would take place if there was a fault in one of the armed zones during the duration of the scheduled event, and would typically be a transmission of an alarm message, an activation of a camera, a transmission of an email, and/or a transmission to a user interface. The zone problem action would take place when a zone was being armed while there was a fault in the field. An example is when the security system attempts to arm a zone while the zone has an open gate. The zone problem action would typically be a transmission to a user interface or a transmission of an email. Lastly the zone no-fault action would occur when there was no fault in a disarmed zone for the duration of the scheduled event. An example of this is when a zone is disarmed to allow the entrance of a child and there is no door opened in 30 minutes of the disarm. The zone no-fault action would typically be a transmission of an email.

The next step of the method is comparing a current time with the time information, then reading status information of the security system if the current time matches the time information, and finally executing the event action if the event condition is satisfied by the status information. The current time matches the programmed time information when the current day is equal to the day specified by the time information and when the current time is equal to or greater than the time specified by the time information. The status information, like the event condition information, includes zone setting information, fault information, zone type information, and user input information. The event condition is satisfied by the status information when, for example, the user programs the event condition to have a zone armed for the event action to occur and when the status information is read, it shows that zone as being armed. The method also includes the steps of monitoring the duration of an event action and when the duration is completed stopping the event action. An example of this might be the scheduled disarming of a premise gate for the afternoon on the day of the expected arrival of the landscapers. The security system would automatically arm the gate in the evening.

In order to perform the steps of the invention, the security system includes memory means for storing the conditional scheduled event information, user input means for programming the memory means, a real time clock for providing a current time, means for providing status information, processing means, and an output device for performing the event action. The processing means compares the current time to the time information, compares the status information to the event condition information, and executes the event action. The user input means may be a wall mounted touch pad, a key fob, a telephone connected to the security system through the public telephone system, or a computer connected to the security system through a direct connection or through the internet. The means for providing status information may be a dedicated register or a shared memory location. The output device may be an alarm transmitter, a telephone dialer, a user email interface, a camera, a chime transmitter, or a voice message transmitter. The security system also includes a duration counter for monitoring the duration of the event action.

### BRIEF DESCRIPTION OF THE DRAWING

FIG. 1 is a diagram of the security system components of the present invention.

FIG. 2 is a block diagram of the security system of the present invention.

FIG. 3 is a flowchart of the present invention.

### BEST MODE FOR CARRYING OUT THE INVENTION

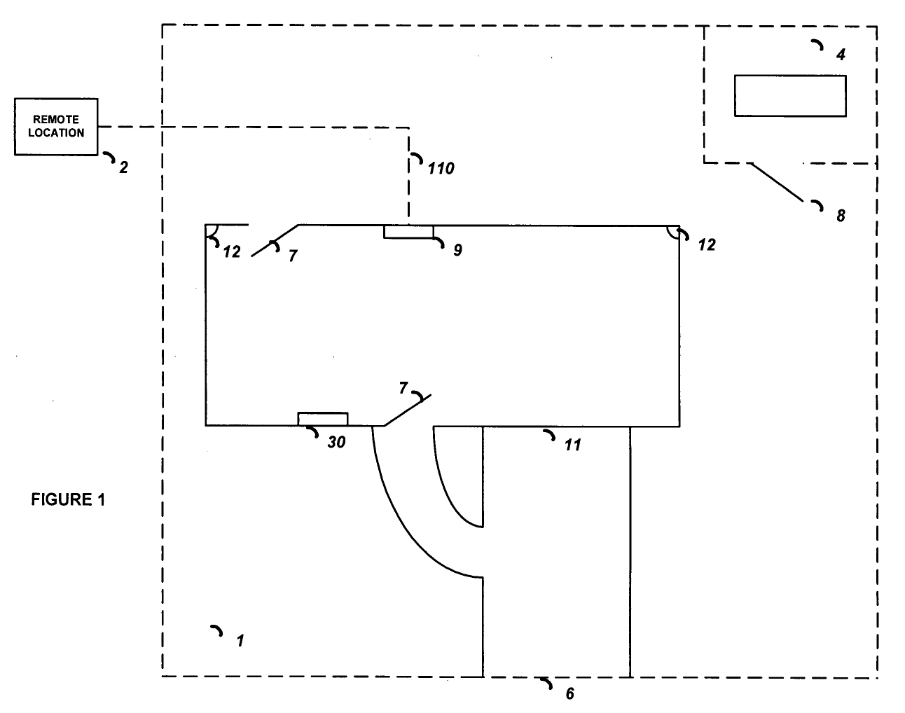

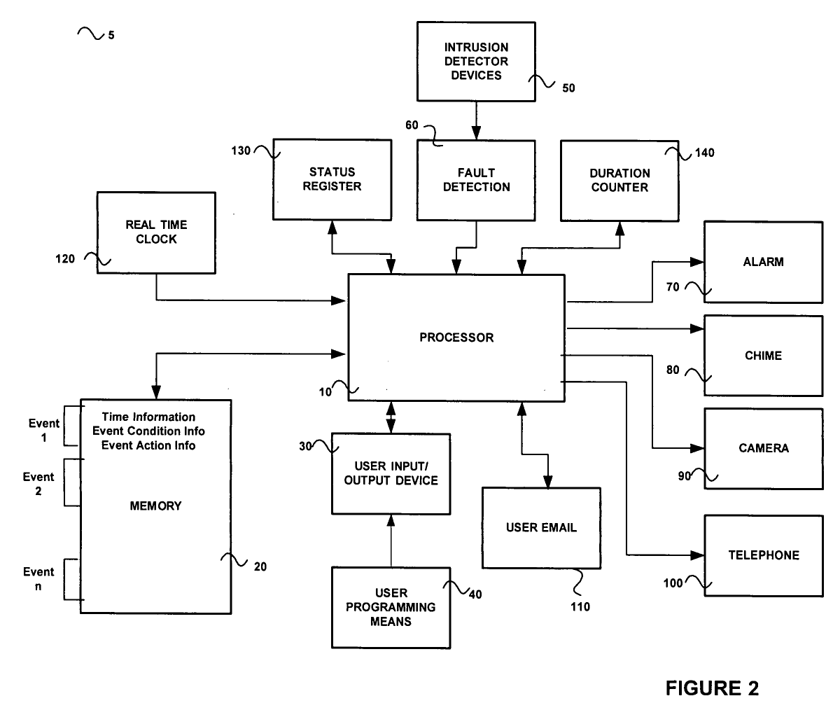

The preferred embodiments of the present invention will now be described with respect to the Figures. FIG. 1 shows a premise 1 monitored by a security system 5 (block diagram shown in FIG. 2). Also shown in FIG. 1 is an off site location 2, possibly a work site. The present invention allows an end user (homeowner) to conditionally schedule the security system 5 to perform events that will help the end user to better monitor the premise 1. For example, on Thursdays when the end user leaves for work to off site location 2, he arms-away the security system 5 using user input/output device 30 (shown as a wall mounted keypad but may also be a key fob). Once the security system 5 has been armed, the intrusion detection devices 50 (shown in FIG. 2), which include front gate 6 sensor, door 7 sensors, motion detectors 12, pool gate 8 sensor, and garage 11 sensor, give fault information to security panel 9 as well known in the art.

In the present invention, the end user has the ability to schedule, using user programming means 40 (shown in FIG. 2) located on user input/output device 30, the front gate 6 and pool gate 8 to be disarmed between 12 pm and 3 pm to allow the landscapers access to the premise 1. The security system 5 compares the current time and day with the scheduled time and day to determine when it is 12 pm Thursday. It also checks that the status of the security system 5 is armed-away. If the security system 5 was disarmed or armed-stay the children might be home and they would have access to the pool area 4. The security system 5 also determines (or reads from memory) the duration of the scheduled event and arms the front gate 6 and the pool gate 8 after 3 hours have expired. An additional feature of the present invention is that the end user can program the security system 5 to perform other actions based on the status of the security system 5 during the scheduled event. For instance, when there is a fault from the front gate 6 after it has been disabled, the security system activates the camera 90 and sends an email message over the internet 110 to the end user at work site 2 that includes the camera 90 footage. The end user can be sure that the person entering the premise 1 is the landscaper. Another example would be when the landscaper doesn't show up during the three hour duration, the security system sends and email to the end user. Yet another action might occur when the security system 5 tries to rearm the pool gate 8 and the landscapers have left it open. An email can be sent to the end user notifying him of the problem. He can then call the landscaper and have them correct the problem. This is only one example of a conditional scheduled event. The security system 5 may be programmed for many conditional scheduled events which may include the house cleaners cleaning the house 3, the children arriving home, etc. In each of these scheduled events the end user programs the security system 5 with the scheduled time, the duration of the event, the condition of the security system 5 if the event is to take place, and the actions that the security system should perform.

The components of security system 5 for the present invention are shown in FIG. 2. The intrusion detection devices 50, describe above, are connected to the fault detection circuit 60, which determines when a fault has occurred in one of the zones and notifies the processor 10. A zone may be a single sensor such as front gate 6 or may include multiple sensors such as all motion detectors 12. The end user programs the security system 5 through the user programming means 40. The user programming means 40 may be dedicated keys on the key pad or may be a computer that is interfaced to the user input/output means 30 or directly to the processor 10. The user may program the security system to be armed-away, armed-stay, or disarmed. If the security system is armed and a fault has occurred the actions the processor 10 may take are to sound an alarm 70, cause a chime 80, activate a camera 90, dial a security service via a telephone connection 100, or email a user 110. The operation of the security system 5 and its components are well known to one skilled in the art and will not be described in detail.

In accordance with the present invention, the security system 5 allows the end user to program selected events to be performed at a user selected times, conditions, and durations. The events include zone setting actions, zone fault actions, zone problem actions, and zone no-fault actions. The zone setting actions may be either arming (stay or away) a zone, disarming a zone, and changing a zone type (day, night, 24 hour). The zone fault actions, which occur when there is a fault in an armed zone, may be sounding an alarm 70, causing a chime 80, activating a camera 90, dialing a security service via a telephone connection 100, emailing a user 110, and/or transmitting a voice message to the user input/output device 30. The zone problem actions, which occur when a fault exists while arming a zone, may be to cause a chime 80, activate a camera 90, email a user 110, and/or transmit a voice message to the user input/output device 30. Lastly, the zone no-fault action, which occurs when there is no fault for the duration of a zone being disarmed, is emailing a user 110. The events along with the event time information and the event condition information are programmed into memory device 20 through the user programming means 40. The processor 10 executes the event when the current time, supplied by real time clock 120, is equal to or greater than the stored event time and when the status, supplied by status register 130, satisfies the stored event condition. The processor 10 also initiates duration counter 140 with the duration of the event stored as part of the event time information. The stored time information in memory 20, the current time from real time clock 120, and the duration counter 140 all contain date information, day of the week information, and time of the day information. The event condition stored in memory 20 and the status from status register 130 both include zone information for each zone, fault information, zone type information, and information about a holiday, a pet on the premise, or a child on the premise. The memory 20 stores multiple events each containing time information, condition information, and action information.

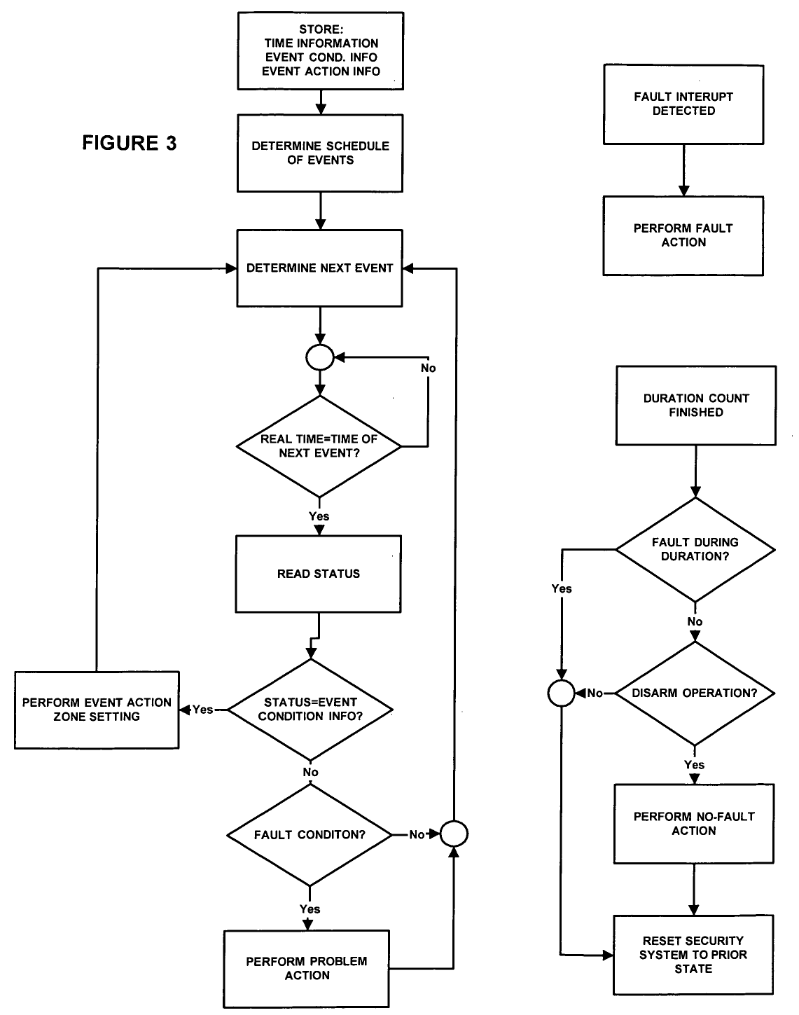

FIG. 3 shows a flowchart of the operations performed by the processor 10 for performing conditional scheduled events. The processor 10 programs the memory 20 with the event information programmed by an end user into the user programming means 40. The processor 10 determines a schedule of events using the time information of each event. The processor 10 determines the time of the next event and compares it to the current time from the real time clock 120. The processor 10 reads the status from the status register 130 and compares it to the event condition information of the next event. If the status is equal to the event condition, the processor 10 performs the event action zone setting, i.e. zone arming or disarming and starts the duration counter with the duration information of the event. If the status is not equal to the event condition, the processor 10 determines if it is because of a fault problem. If it is because of a fault problem, the processor 10 performs the problem action specified by the event action information. After each action, the processor 10 starts the process again by determining the next scheduled event. The processor 10 also waits for a fault to be detected by the fault detection circuit 60 and for the duration counter 140 to finish. If a fault is detected the processor 10 performs the programmed fault action. If the duration counter 140 is finished the processor 10 determines if there was a fault during the duration and if not determines if the zones were disarmed and if they were the processor performs the programmed no-fault action. The processor 10 then resets the security system to its state before the event took place.

It will be apparent to those skilled in the art that modifications to the specific embodiment described herein may be made while still being within the spirit and scope of the present invention. For example, the memory 20 may be programmed differently with additional information or less information. The status register 130 may also contain different information or may be a memory location rather than a register. The fault detection circuit 60, the real time clock 120, and the duration counter 140 may be design in many different ways to accomplish the basic functions of the circuits. The processor 10 may also execute different operations and may perform them in a different sequence. Lastly there may be multiple status registers, fault detection circuits, and duration counters to perform concurrent scheduled events.

What is claimed is:

1. A method of operating a security system with conditional scheduled events, wherein the security system comprises at least one security zone, comprising the steps of:
a. programming a memory with at least one conditional scheduled event comprising:
i. time information for the conditional scheduled event to occur,
ii. event condition information, and
iii. event action information;
b. comparing a current time with said time information for the conditional scheduled event, and
c. if said current time matches said time information for the conditional scheduled event then,
i. reading status information of the security system, and
ii. if said event condition is satisfied by said status information, then
(i) executing said event action specified by said conditional scheduled event.

2. The method of claim 1 wherein said event time information comprises event duration information and wherein the method further comprises the step of monitoring the event duration when executing said event action.

3. The method of claim 2 further comprising the step of stopping said event action when said event duration is complete.

4. The method of claim 1 wherein said event condition information comprises zone setting information.

5. The method of claim 1 wherein said event condition information comprises fault information.

6. The method of claim 1 wherein said event condition information comprises zone type information.

7. The method of claim 1 wherein said event action comprises transmitting an alarm message.

8. The method of claim 1 wherein said event action comprises transmitting an email.

9. The method of claim 1 wherein said event action comprises transmitting a user interface message.

10. The method of claim 1 wherein said event action comprises activating at least one zone.

11. The method of claim 1 wherein said event action comprises activating a camera.

12. The method of claim 1 wherein said event action comprises deactivating at least one zone.

13. A security system comprising:
a. memory means for storing at least one conditional scheduled event, wherein the conditional scheduled event comprises:
i. time information for the conditional scheduled event to occur,
ii. event condition information, and
iii. event action information;
b. user input means for programming said memory means,
c. a real time clock for providing a current time,
d. means for providing status information,
e. processing means for
i. comparing said current time to said time information for the conditional scheduled event to occur,
ii. comparing said status information to said event condition information, and
iii. executing said event action specified by said conditional scheduled event when said current time matches said time information for the conditional scheduled event to occur, and when said status information satisfies said event condition specified by said conditional scheduled event, and
f. an output device for performing said event action.

14. The system of claim 13 wherein said event time information further comprises time duration information, and wherein said security system further comprises a time counter for monitoring the duration of said conditional scheduled event.

15. The system of claim 13 wherein said output device is an alarm transmitter.

16. The system of claim 13 wherein said output device is a telephone dialer.

17. The system of claim 13 wherein said output device is a user email interface.

18. The system of claim 13 wherein said output device is a camera.

19. The system of claim 13 wherein said output device is a chime transmitter.

20. The system of claim 13 wherein said output device is a voice message transmitter.

21. The system of claim 13 wherein said status information comprises zone setting information.

22. The system of claim 13 wherein said status information comprises fault information.

23. The system of claim 13 wherein said status information comprises zone type information.
